(19) United States
(12) Patent Application Publication
(10) Pub. No.: US 2021/0387309 A1
(43) Pub. Date: Dec. 16, 2021

(54) ENHANCED INTENSITY CAVITATION NOZZLES

(71) Applicant: The Boeing Company, Chicago, IL (US)

(72) Inventors: Daniel Gordon Sanders, Cle Elum, WA (US); Shreyes N. Melkote, Roswell, GA (US); Amey Vidvans, Atlanta, GA (US); Gurpreet Singh, Schenectady, NY (US)

(73) Assignee: The Boeing Company, Chicago, IL (US)

(21) Appl. No.: 17/331,091

(22) Filed: May 26, 2021

Related U.S. Application Data
(60) Provisional application No. 63/038,586, filed on Jun. 12, 2020.

(51) Int. Cl. B24C 1/10; B24C 5/04

(52) U.S. Cl. CPC B24C 1/10; B24C 5/04

(57) ABSTRACT

An apparatus for cavitation peening is disclosed, including a fluid source, a conduit, and a portable nozzle assembly. The conduit includes a proximal end portion connected to the fluid source and a distal end portion connected to the portable nozzle assembly. The portable nozzle assembly includes an inner nozzle configured to channel a first stream of high-pressure fluid, and an outer nozzle configured to channel a second stream of low-pressure fluid concentrically around the first stream. The inner nozzle includes a cavitation insert having an inner passage with at least two reductions in cross-sectional area.

### CROSS-REFERENCES

This application claims the benefit under 35 U.S.C. § 119(e) of the priority of U.S. Provisional Patent Application Ser. No. 63/038,586, filed Jun. 12, 2020, the entirety of which is hereby incorporated by reference for all purposes.

### BACKGROUND

Surface integrity enhancement and smoothing of critical surfaces of components used in aerospace and allied industries is of paramount importance to increase their corrosion and fretting fatigue resistance, improve fatigue life, and allow use of new additive manufacturing techniques. Cavitation processes such as Cavitation Peening (CP) and Cavitation Abrasive Surface Finishing (CASF) can be cheaper, safer, faster, and have a lower environmental impact than previous methods of surface treatment. Inexpensive water and inert abrasives can be used in place of expensive and potentially dangerous shot media, chemical cleaners, acids, or high-power laser beams.

Cavitation processes utilize the impact pressures generated by cavitation bubble collapse on metallic surfaces to induce beneficial compressive residual stresses and/or energize abrasive particles to remove material on impact. One common process configuration includes submerging the treated component in a reservoir of fluid. Another configuration includes encapsulating a high-speed jet in a low-speed jet of fluid. This configuration is known as co-flow due to the concentricity of the low- and high-speed flows.

To decrease processing time and improve process capability for practical applications, a nozzle with increased cavitation intensity would be beneficial.

### SUMMARY

The present disclosure provides systems, apparatus, and methods relating to cavitation peening. In some examples, an apparatus for cavitation peening may include a fluid source, a conduit, and a portable nozzle assembly. The conduit may include a proximal end portion connected to the fluid source and a distal end portion connected to the portable nozzle assembly. The portable nozzle assembly may include an inner nozzle configured to channel a first stream of high-pressure fluid, and an outer nozzle configured to channel a second stream of low-pressure fluid concentrically around the first stream. The inner nozzle may include a cavitation insert having an inner passage with at least two reductions in cross-sectional area.

In some examples, a cavitation peening nozzle may include a cylindrical pipe and an organ pipe cavitator at a distal end of the pipe, configured to deliver a cavitating jet of high-pressure fluid. An inner passage of the cavitator may include a proximal section, a middle section, and a distal section. The proximal section may have a first inner diameter, the middle section may have a second inner diameter, and the distal section may have a third inner diameter. The first inner diameter may be larger than the second inner diameter, and the second inner diameter may be larger than the third inner diameter.

In some examples, a cavitation peening nozzle may include a cylindrical pipe and an organ pipe cavitator at a distal end of the pipe, configured to deliver a cavitating jet of high-pressure fluid. An inner passage of the cavitator may include an outlet section which converges from a proximal opening to a smaller distal opening.

Features, functions, and advantages may be achieved independently in various examples of the present disclosure, or may be combined in yet other examples, further details of which can be seen with reference to the following description and drawings.

### BRIEF DESCRIPTION OF THE DRAWINGS

FIG. 1 is a block diagram of an illustrative cavitation peening system, in accordance with aspects of the present disclosure.

FIG. 2 is a schematic diagram of an illustrative portable cavitation peening system.

FIG. 3 is a cross-sectional view of an illustrative co-flow nozzle assembly, in accordance with aspects of the present disclosure.

FIG. 4 is an exploded cross-sectional view of the nozzle assembly of FIG. 3.

FIG. 5. is a cross-sectional detail view of a tip portion of the nozzle assembly of FIG. 3, without a cavitation insert.

FIG. 6 is an axial view of the homogenizing plate of the nozzle assembly of FIG. 3.

FIG. 7 is a isometric view of the centering ring of the nozzle assembly of FIG. 3.

FIG. 8 is a schematic diagram of a first illustrative cavitation insert of the nozzle assembly of FIG. 3.

FIG. 9 is a schematic diagram of a second illustrative cavitation insert of the nozzle assembly of FIG. 3.

FIG. 10 is a schematic diagram of a third illustrative cavitation insert of the nozzle assembly of FIG. 3.

FIG. 11 is a schematic diagram of a fourth illustrative cavitation insert of the nozzle assembly of FIG. 3.

FIG. 12 is a schematic detail view of a first illustrative outlet of a cavitation insert of the cavitation insert of FIG. 3.

FIG. 13 is a schematic detail view of a second illustrative outlet of a cavitation insert of the cavitation insert of FIG. 3.

FIG. 14 is a schematic detail view of a third illustrative outlet of a cavitation insert of the cavitation insert of FIG. 3.

FIG. 15 is a flow chart depicting steps of an illustrative method for cavitation peening, according to the present teachings.

### DETAILED DESCRIPTION

Various aspects and examples of a cavitation nozzle assembly with enhanced cavitation intensity, as well as related systems and methods, are described below and illustrated in the associated drawings. Unless otherwise specified, a nozzle assembly in accordance with the present teachings, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed examples. The following description of various examples is merely illustrative in nature and is in no way intended to limit the disclosure, its application, or uses. Additionally, the advantages provided by the examples described below are illustrative in nature and not all examples provide the same advantages or the same degree of advantages.

This Detailed Description includes the following sections, which follow immediately below: (1) Overview; (2) Examples, Components, and Alternatives; (3) Illustrative Combinations and Additional Examples; (4) Advantages, Features, and Benefits; and (5) Conclusion. The Examples, Components, and Alternatives section is further divided into subsections A and B, each of which is labeled accordingly.

### Overview

In general, an enhanced intensity cavitation nozzle may include an inner passage with geometry configured to alter flow dynamics of a discharged jet of fluid. For example, the inner passage may include a resonance chamber configured to intensify fluctuations in the jet. For another example, the inner passage may have a conical outlet configured to increase exit velocity of the jet. Dimensions of the inner passage geometry such as resonance chamber length or angle of conicity may be selected or tuned to optimize resulting increases to cavitation intensity. The inner passage geometry may increase cavitation intensity without requiring an increased flow rate.

The enhanced intensity cavitation nozzle may be part of a nozzle assembly used in a cavitation peening system. In some examples, the system may include a liquid environment such as a tank filled with water, and the nozzle may be configured for use in such a static water column. In some examples, the system may be designed for hand-held or other use in an air environment, and the nozzle assembly may include an outer nozzle to channel an outer jet of fluid concentric with the jet of fluid discharged by the cavitation nozzle. Such a nozzle assembly may be referred to as a co-flow nozzle or co-flow nozzle assembly.

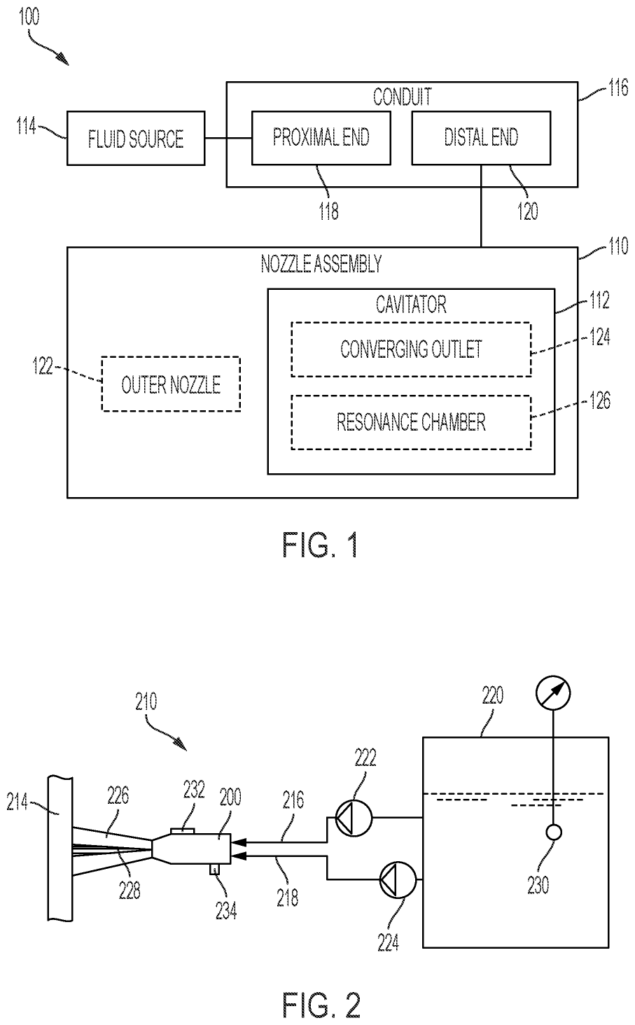

FIG. 1 is a block diagram of an illustrative cavitation peening system 100, including an example of an enhanced intensity cavitation nozzle referred to as a cavitator 110. The cavitator may also be referred to as a cavitation nozzle and/or a cavitation insert. Cavitator 110 is part of a nozzle assembly 112. A fluid source 114 supplies fluid to the nozzle assembly through a conduit 116. A proximal end portion 118 of conduit 116 is connected to fluid source 114, and a distal end portion 120 of the conduit is connected to nozzle assembly 112. Conduit 116 may include a high-pressure hose along with any other appropriate fluid and/or electrical connections.

Fluid source 114 delivers high-pressure fluid through conduit 116 to nozzle assembly 112. The fluid source may include a high-pressure fluid pump and a supply of fluid such as a water tank or a connection to a municipal water supply. The fluid source may also include one or more additional pumps and/or types of fluid, according to a selected processing method or methods. For example, the fluid source may include a pump configured for low-pressure operation and/or may include a supply of an abrasive slurry, for use with co-flow cavitation nozzles and/or for abrasive surface finishing.

High-pressure fluid from fluid source 114 may be dispensed from cavitator 110 of nozzle assembly 112 toward a workpiece surface and/or into a treatment zone as a cavitating jet. The cavitating jet may interact with a fluid environment to form cavitation bubbles. In some examples, the cavitation bubbles may excite particles of an abrasive suspended in the fluid environment. A workpiece may be thereby peened and surface finished.

In some examples, nozzle assembly 112 may include outer nozzle 122. In such examples, fluid source 114 may also deliver low-pressure fluid to nozzle assembly 112, which may be dispensed by outer nozzle 122 to form the fluid environment for the formation of cavitation bubbles. In some examples, nozzle assembly 112 may be submerged in a fluid environment such as a tank filled with water or an abrasive slurry.

Any desired fluid may be used for cavitation. Water may be preferred, as an inexpensive fluid that is safe and easy to work with. Properties such as viscosity of the fluid used may affect collapsing force of cavitation bubbles and a fluid may be chosen to improve impact, or decrease the pressure required for a desired impact level. The fluid may also be selected according to properties of an abrasive material used, and/or to achieve desired properties of an abrasive slurry.

Cavitator 110 may include either or both of a converging outlet 124 and a resonance chamber 126. In such examples, the cavitator may be described as a converging cavitator or an organ pipe cavitator, respectively. Each intensity feature may alter flow dynamics of the cavitating jet dispensed by cavitator 110, thereby increasing intensity of the cavitation produced by nozzle assembly 112. Converging outlet 124 may be formed by a reduction in cross-sectional area of a section of an inner bore of cavitator 110, immediately adjacent an exit aperture of the cavitator. The converging outlet may be defined by angled inner walls of the inner bore. Resonance chamber 126 may be formed in the cavitator between first and second reductions in cross-sectional area of a cylindrical inner bore. The resonance chamber may also be referred to as an organ pipe geometry of cavitator 110.

### Examples, Components, and Alternatives

The following sections describe selected aspects of exemplary cavitation nozzle assemblies as well as related systems and/or methods. The examples in these sections are intended for illustration and should not be interpreted as limiting the entire scope of the present disclosure. Each section may include one or more distinct examples, and/or contextual or related information, function, and/or structure.

### A. Illustrative Co-Flow Nozzle Assembly

As shown in FIGS. 2-14, this section describes an illustrative co-flow cavitation nozzle assembly 200 including modular enhanced intensity cavitation nozzle inserts 300, which may be referred to as cavitation inserts. Cavitation nozzle inserts 300 are examples of an enhanced intensity cavitation nozzle, and co-flow cavitation nozzle assembly 200 is an example of a nozzle assembly, as described above.

FIG. 2 is a schematic diagram of an illustrative portable water cavitation peening (PWCP) system generally indicated at 210, including nozzle assembly 200. The nozzle assembly is directed at a treatment surface 214, which may be a surface of a workpiece and/or may be described as a work site. Two flexible conduits 216, 218 supply pressurized water to the nozzle assembly, with each conduit connected to the nozzle assembly at a distal end. A tank 220 supplies water to two pumps, a first pump 222 connected to a proximal end of conduit 116 and a second pump 224 connected to a proximal end of conduit 218. First pump 222 pressurizes the water to a first pressure, and second pump 224 pressurizes the water to a second, lower, pressure.

Nozzle assembly 200 discharges a first stream 226 of water at the first pressure, and a second stream 228 at the second pressure. The two streams are discharged concentrically, such that the streams combine to generate a cloud of cavitation bubbles. An operator may maintain nozzle assembly 200 at a selected standoff distance from treatment surface 214, according to factors including but not limited to estimated cavitation intensity, nozzle geometry, material of treatment surface 214, and/or desired treatment. For example, the standoff distance may be approximately equal to twice a length of the generated cloud of cavitation bubbles.

The co-flow configuration of nozzle assembly 200 may facilitate a broader range of applications for system 210. Without size limitations or other constraints imposed by the need to submerge treated parts, the portable system may be used in the field for peening of repairs, for treatment of final assemblies, and/or on large scale components such as aircraft skin sections.

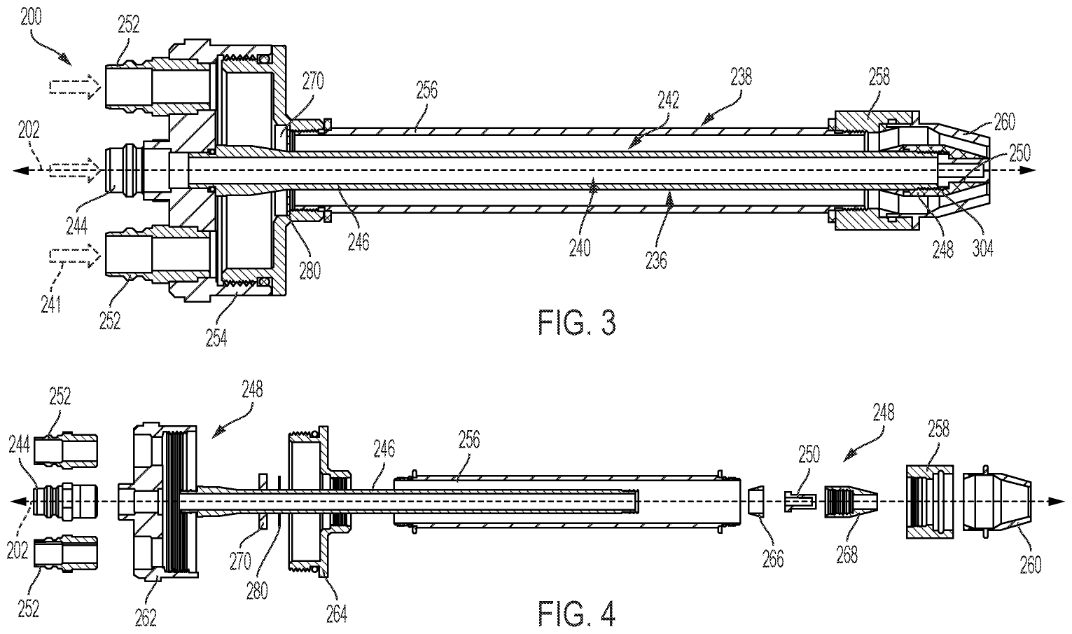

Nozzle assembly 200 is operated manually, and is designed for hand-held use. More specifically, individual components and overall design of the nozzle assembly are configured to minimize size and weight, as described further with reference to FIGS. 3-7 below. In the present example, nozzle assembly weighs 3 pounds (lbs). Preferably, the nozzle assembly may have a weight of approximately 5 lbs or less, to facilitate extended manual use with consistent control dexterity and minimal muscle fatigue.

Nozzle assembly further includes an actuator 234 and a feedback mechanism 232. Actuator 234 is configured for manual manipulation, for instance the actuator may include a mechanical trigger. Feedback mechanism 232 is configured to indicate a relative extent of surface modification at a work site being acted on by the nozzle assembly, in the present example treatment surface 214. For example, the feedback mechanism may include a display showing a color map of calculated treatment duration for a pre-selected treatment zone, and/or showing a reading from an impact sensor positioned on the treatment surface. In some examples, the nozzle assembly may further include sensors, human readable indicators, and/or controls for system parameters such as water temperature and pressure.

In some examples, nozzle assembly 200 may be designed for integration with an automated system and/or may be operated by a CNC robotic arm. In such examples, the nozzle assembly may include appropriate features such as a remote trigger, threading or other fastening features complementary to a robotic arm attachment, and/or a built-in programmable logic controller.

A sensor cluster 230 is submerged in the water of tank 220 to monitor the water for relevant parameters. For example, the cluster may include sensors for temperature, pressure, fluid level, viscosity, salinity, carbonate content, metal content and/or oxygen content. In some examples, system 210 may further include sensors in conduits 216, 218 and/or nozzle assembly 200 such as one or more pressure gauges and/or flow meters. Data from sensor cluster 230 may be displayed by visual indicators on an exterior surface of the tank. The data may also be output to an electronic controller, or communicated to an operator by visual, auditory, or other means.

In some examples, system 210 may further include components or equipment to optimize relevant properties of the flow delivered to nozzle assembly 200. Examples include filters, valves, temperature controls, and pulsation dampeners.

First and second pressures, flow volumes and velocities, and water temperature for system 210 may be selected according to desired cavitation intensity as well as size and geometry of nozzle assembly 200, as discussed further below. In the present example, system 210 is configured for water cavitation peening of machined, turned, cut, ground, abrasive finished and/or additively manufactured metal parts such as aircraft components of aluminum, corrosion resistant steel (CRES), superalloys, and/or titanium. Flow delivered to the nozzle assembly from pump 222 by conduit 216 is maintained at approximately 25 megapascals (MPa) and 150 meters per second (m/s). Flow delivered to the nozzle assembly from pump 224 by conduit 218 is maintained at approximately 0.1 MPa and 10 m/s. Water supplied by each pump is approximately 30 degrees Celsius.

In general, any effective pressures, flow velocities, and/or temperatures may be used. Appropriate values may also vary in examples where fluids other than water are used. Preferably, an operating temperature close to room temperature may be used, to avoid the need for significant heating or cooling. For many applications, a first pressure between approximately 5 and 35 MPa and any second pressure sufficient to generate homogeneous flow may be effective. Flow velocity may be limited by pump capacity and nozzle size. Preferably, both flow velocity and nozzle size may be minimized to allow use of lower capacity pumps that are less expensive.

As shown in the cross-sectional view of FIG. 3, nozzle assembly 200 includes an inner nozzle 236 and an outer nozzle 238, which define an inner flow channel 240 and an outer flow channel 242, respectively. Dimensions of nozzle assembly 200 may be selected to minimize weight while maintaining desired cavitation intensity. In the present example, the nozzle assembly is approximately 45 centimeters (cm) in overall length. Preferably, the nozzle assembly may be between approximately 15 and 60 cm for hand-held peening of metal. Other sizes may be appropriate to other applications.

Similarly, nozzle materials may be selected to minimize weight while providing sufficient strength to tolerate water pressure and resist damage from cavitation. In the present example, the nozzle assembly components include aluminum alloys and stainless steel, in addition to brass fittings and elastomer O-ring seals. Any sufficiently light and strong material or materials may be used. The nozzle and/or nozzle components may be manufactured by any effective means, including but not limited to additive manufacturing, turning, casting, and machining.

Nozzle assembly 200 may be described as having a central axis 202, about which both inner nozzle 236 and outer nozzle 238 are concentric. Outer flow channel 242 and inner flow channel 240 are configured to deliver concentric homogeneous streams of fluid appropriate to generation of a cloud of cavitation bubbles. The stream generated by inner flow channel 240 may be described as a cavitating jet, and is delivered at higher pressure than the surrounding stream generated by outer flow channel 242. Fluid flows through the inner and outer flow channels in a direction indicated by arrows 241.

Inner nozzle 236 includes a high-pressure inlet 244, an inner pipe 246, an inner tip portion 248, and a modular cavitation nozzle insert 250. High-pressure inlet is connected to conduit 216 (FIG. 2), and a first end of inner pipe 246. A second end of inner pipe 246 is received by inner tip portion 248, and threadedly engages the inner tip portion. Cavitation insert 250 is entirely received by inner tip portion 248, and is secured in position between the second end of the inner pipe and the inner tip portion.

Outer nozzle 238 includes four low-pressure inlets 252, an inlet manifold 254, an outer pipe 256, a tip connector 258, and an outer tip portion 260. Low-pressure inlets 252 are arranged symmetrically about central axis 202, and may be described as positioned at the vertices of a square. Two of the four inlets are depicted in FIGS. 3 and 4. Each inlet 252 is connected to inlet manifold 254, which is threadedly secured to a first end of outer pipe 256. Tip connector 258 threadedly engages a second end of outer pipe 256, and outer tip portion is fastened to the tip connector by screws, to attach outer tip portion 260 to the outer pipe.

FIG. 4 is an exploded cross-sectional view of nozzle assembly 200, showing in further detail the components of inner nozzle 236 and outer nozzle 238. As shown, inlet manifold 254 includes a proximal section 262 and a distal section 264. The proximal section includes recesses to receive high-pressure inlet 244 and low-pressure inlets 252, and the distal section includes a constriction to snugly receive outer pipe 256. Proximal section 262 and distal section 264 screw together to define a sealed manifold to collect water from low-pressure inlets 252 for communication to outer pipe 256.

Inner tip portion 248 also includes a proximal section 266 and a distal section 268. The proximal section includes a wedge shape, and abuts a flat proximal end of the distal section to provide a smooth surface in outer flow channel 242. Together the two sections facilitate a strong connection and seal between inner tip portion 248 and inner pipe 246, while minimizing impact on the outer flow channel.

Nozzle assembly 200 may be divided into components and sections as depicted in FIG. 4, or may be divided into more or fewer parts. Division as depicted in the present example may allow low-cost construction and facilitate disassembly for cleaning, part replacement, or exchange of modular cavitation inserts as discussed further below.

Outer nozzle 238 is concentric with inner nozzle 236, and the inner nozzle extends through the outer nozzle. To maintain precise concentricity, nozzle assembly 200 includes a centering ring 270. In some examples, one or more additional centering rings may be used for purposes of stability.

As shown in FIG. 3, centering ring 270 is disposed in a recess of inlet manifold 254 and contacts both the inlet manifold and inner pipe 246 to maintain relative positioning between the inner and outer nozzles. An isometric view of centering ring 270 is depicted in FIG. 7, showing a central aperture 272 and two arcuate flow apertures 274. The central aperture is sized to snugly receive the inner pipe, and an outer peripheral surface 276 is configured to fit against the recess of the inlet manifold. Centering ring is circular to correspond to the cylindrical pipes of the inner and outer nozzles. Flow apertures 274 are configured to allow maximum flow through centering ring 270 without adverse effect to strength of the ring.

Referring again to FIGS. 3 and 4, nozzle assembly 200 further includes a perforated plate 280, to improve homogeneity of flow through outer flow channel 242. The perforated plate is disposed immediately downstream of centering ring 270, and similarly received in the recess of inlet manifold 254. The plate may be thereby disposed to remove turbulence and inhomogeneity resulting from mixing in the manifold, and deliver smooth flow down outer pipe 256. An axial view of perforated plate 280 is depicted in FIG. 6, showing a central aperture 282 and a plurality of smaller circular flow apertures 284. The central aperture is sized to snugly receive the inner pipe, and an outer peripheral edge 286 is configured to fit against the recess of the inlet manifold. Flow apertures 284 are arranged with radial symmetry for symmetrical flow.

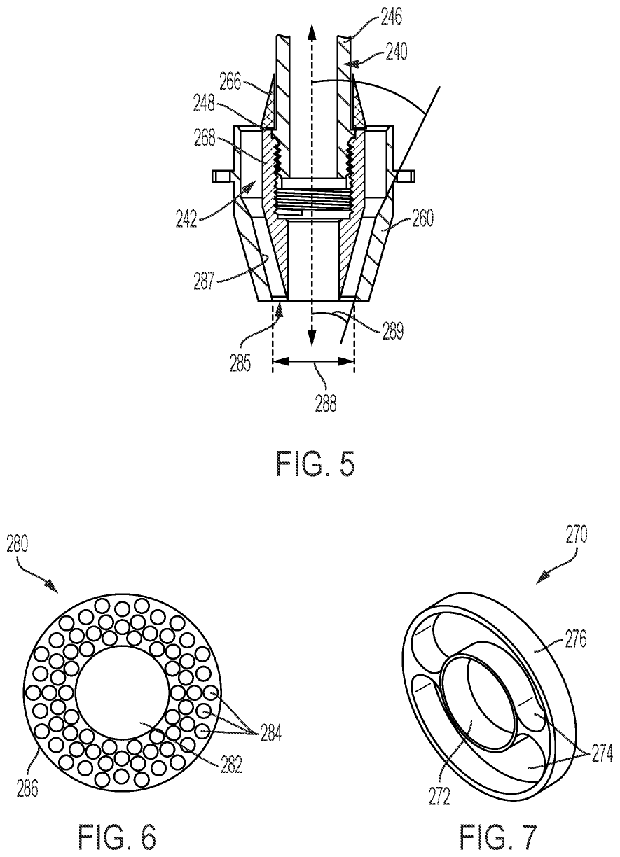

As shown in FIG. 5, outer tip portion 260 converges to a distal exit opening 285. An inner wall 287 of the outer tip portion is angled inward in two steps, a first step angled at approximately 30 degrees relative to central axis 202 and a second step angled at approximately 15 degrees relative to the central axis. That is, a distal-most or outlet portion of inner wall 287 forms an oblique angle 289 with central axis 202 of approximately 15 degrees. Preferably, angle 289 may be between approximately 5 and 45 degrees.

As outer tip portion 260 converges, a cross-sectional area of outer flow channel 242 decreases. The cross-section of the outer flow channel at the outer tip portion is annular, as defined between inner wall 287 and inner tip portion 248. The cross-sectional area of the outer flow channel is proportional to the difference between the square of an inner diameter 288 of outer tip portion 260 and the square of an outer diameter of inner tip portion 248.

In the present example, at exit opening 285, inner diameter 288 of outer tip portion 260 is approximately 25 millimeters (mm), the outer diameter of inner tip portion 248 is approximately 12 mm, and the cross-sectional area of outer flow channel 242 is approximately 380 mm². In general, dimensions of outer tip portion 260 may be proportion to overall nozzle size. A larger outlet area and greater flow volume may increase cavitation intensity. However, greater flow volume may necessitate use of a larger volume of water and pump with greater capacity, increasing equipment and processing costs. Therefore achieving desired cavitation intensity with nozzle geometry and a limited flow may be preferable. Accordingly, inner diameter 288 may preferably be less than approximately 50 mm.

Referring again to FIG. 3, during operation of nozzle assembly 200 high-pressure water travels through inner flow channel 240 from high-pressure inlet 244, through inner pipe 246, and out of cavitation insert 250. Inner flow channel is defined largely by cylindrical inner pipe 246, with a generally circular cross-sectional shape. The high-pressure flow is transformed into a cavitating jet by cavitation insert 250. Low-pressure water travels through outer flow channel 242 from low-pressure inlets 252 through inlet manifold 254, centering ring 270, perforated plate 280, and outer pipe 256, then out of outer tip portion 260. Outer flow channel 242 is defined between outer pipe 256 and inner pipe 246, then between outer tip portion 260 and inner tip portion 248, with a generally annular shape.

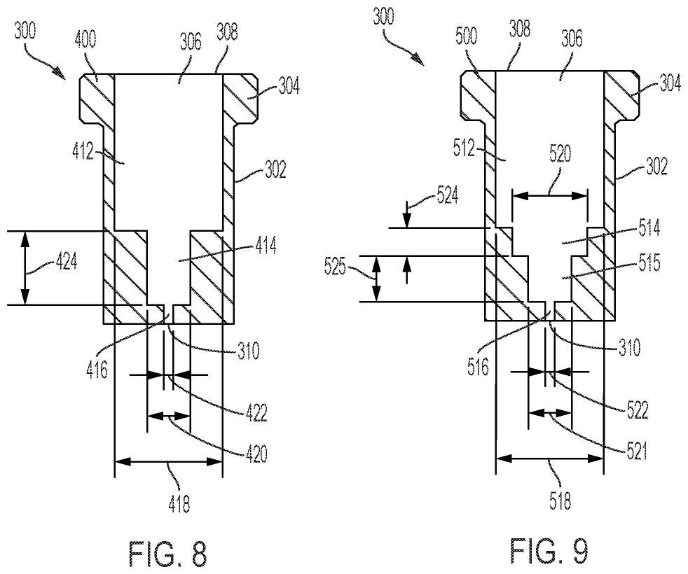

In the present example, nozzle assembly 200 further includes a plurality of enhanced intensity cavitation nozzle inserts 300, as shown in FIGS. 8-14 and described further below. In FIGS. 3 and 4, depicted cavitation insert 250 includes cavitation nozzle geometry known in the art, specifically a cylindrical bore with a single constriction to a cylindrical outlet. Cavitation insert 250 may be described as an unexcited or an unenhanced insert. Nozzle inserts 300 each include geometry to enhance cavitation intensity, and may preferably be used over unexcited cavitation insert 250.

In general, nozzle assembly 200 may be used with a single cavitation insert design, may be used with multiple cavitation insert designs, and/or may include a plurality of interchangeable cavitation inserts. Use of an insert rather than a unitary inner nozzle may reduce cost to replace components damaged by long-term exposure to cavitation, and facilitate change of nozzle geometry as desired to tune nozzle assembly 200 for specific peening applications.

Each insert 250, 300 includes matching outer geometry, complementary to inner tip portion 248. More specifically, each insert includes a cylindrical outer wall 302 with a shoulder 304 at a proximal end, as shown in FIGS. 8-11. An inner passage 306 extends from a planar proximal surface with a circular inlet opening 308 to a planar distal surface with a smaller circular exit opening 310. Geometry of inner passage 306 between the inlet and exit openings, and size of exit opening 310 vary among the plurality of inserts, while inlet opening 308 has the same size in each insert.

As illustrated by the example of unexcited insert 250 in FIG. 3, each insert is sized to be received snugly and sealed in distal section 268 of inner tip portion 248. Shoulder 304 of the insert is trapped between inner pipe 246 and an inward projection of the inner tip portion. The inner pipe bears against the proximal surface of the insert, to hold the insert fixed relative to nozzle assembly 200. Inner pipe 246 may be unscrewed from inner tip portion 248 to allow replacement or exchange of inserts.

FIGS. 8-14 depict examples of cavitation inserts 300 with geometry of inner passage 306 configured to enhance cavitation intensity. Corresponding reference numbers are used to indicate elements shared across two or more insert designs. It should also be noted that the described and depicted geometries of inner passage 306 may also be used in other nozzle designs such as a co-flow nozzle with a unitary inner nozzle, or a single-flow cavitation nozzle in a stationary water column, to similarly enhance cavitation intensity.

FIG. 8 depicts a first example of an enhanced intensity cavitation nozzle insert 300, a resonant insert 400, with organ pipe geometry. Inner passage 306 of the resonant insert includes three sections: an inlet section 412, a middle section 414, and an outlet section 416. The middle section may be referred to as an organ pipe section. Each section is cylindrical, and the sections are all coaxial. Inlet section 412 has a diameter 418, organ pipe section 414 has a diameter 420, and outlet section 416 has a diameter 422. Diameter 422 of outlet section 416 is also the diameter of exit opening 310. Diameter 418 is larger than diameter 420, which is in turn larger than diameter 422. That is, the inner passage has sequentially smaller diameters.

Resonant insert 400 may also be described as having two constrictions or reductions in cross-sectional area, where the changes in diameter occur, forming the organ pipe geometry. That is, organ pipe section 414 may be defined between the two constrictions. Pressure oscillations occurring at the nozzle exit may be intensified by reflections from the upstream contractions. Such intensification may be referred to as passive excitation and/or self-resonance.

Diameters 418, 420, and 422 may be selected such that there are two consecutive large reductions in cross-sectional area of the internal passage of resonant insert 400 as water travels through the inner nozzle. In other words, the diameters may be selected to be sufficiently different as to generate an organ pipe effect in resonant insert 400. In the present example, diameter 418 is more than two times the size of diameter 420, and diameter 420 is more than four times the size of diameter 422. In some examples, other relative diameters may be selected to optimize the organ pipe effect and/or cavitation intensity.

Organ pipe section 414 may be described as a resonance chamber and/or resonating chamber. The organ pipe section has a length 424, which may be selected according to a desired resonance mode and/or other resonant properties. More specifically, length 424 may be selected according to a wavelength of a desired standing wave. In the present example, resonant insert 400 is configured for a first resonance mode, with a standing wave of four times length 424.

Resonant insert 400 may also be described in terms of a Strouhal number. Length 424 of organ pipe section 414 may determine the pulsation frequency of the resonant insert. The Strouhal number may in turn depend on the pulsation frequency, diameter 422 of outlet section 416, and velocity of the cavitating jet. There may be a critical frequency for a selected geometry, at which cavitation intensity is greatest due to organization of large-scale turbulent motion into cavitating vortex rings. In the present example, resonant insert 400 has a Strouhal number of 0.28. In some examples, the resonant insert may have a Strouhal number between approximately 0.2 and 0.6.

In the present example, diameter 418 is approximately 10 mm, diameter 420 is approximately 4 mm, and diameter 422 is approximately 1 mm. For such dimensions, and the configuration of nozzle assembly 200 as described above, length 424 may be between approximately 5 and 15 mm. As depicted in FIG. 8, length 424 is approximately 7.5 mm and the pulsating frequency of organ pipe section 414 is approximately 50 kilohertz.

In a comparative test between the single-constriction geometry of unexcited cavitation insert 250 and the present example of resonant insert 400, over multiple passes on an aluminum alloy strip at an optimum stand-off distance, the resonant insert demonstrated approximately a 60 percent (%) increase in both mass loss and strip curvature, and increased deeper compressive residual stresses in the material. Analysis of impulse pressure measurements indicated that the enhanced intensity resulted from a higher frequency of strong cavitation events.

FIG. 9 depicts a second example of an enhanced intensity cavitation nozzle insert 300, a dual-chamber resonant insert 500, also with organ pipe geometry. Inner passage 306 of the dual-chamber resonant insert includes four sections: an inlet section 512, a first organ pipe section 514, a second organ pipe section 515, and an outlet section 516. Each section is cylindrical, and the sections are all coaxial. Inlet section 512 has a diameter 518, first organ pipe section 514 has a diameter 520, second organ pipe section 515 has a diameter 521, and outlet section 516 has a diameter 522. Diameter 518 is larger than diameter 520, which is larger than diameter 521, which is in turn larger than diameter 522.

Resonant insert 500 may also be described as having three constrictions or reductions in cross-sectional area, where the changes in diameter occur, forming the organ pipe geometry. That is, each organ pipe section 514, 515 may be defined between two contractions. Pressure oscillations occurring at the nozzle exit may be intensified by reflections from the upstream contractions, similarly to resonant insert 400.

Diameters 520, 521 may be selected such that each constriction constitutes a large reduction in cross-sectional area of the internal passage of resonant insert 500, such that each organ pipe section 514, 515 acts as a resonance chamber. First organ pipe section 514 has a length 524 and second organ pipe section 515 has a length 525. Each length may be selected according to a wavelength of a desired standing wave, resonance mode, and/or Strouhal number.

Inclusion of an additional organ pipe section may increase cavitation intensity, where relative diameters and lengths are selected to achieve effective resonance. In general, a resonant insert may include any number of organ pipe sections and/or resonant chambers. Additional organ pipe sections may necessitate a larger ratio between inlet opening 308 and exit opening 310 in order to achieve sufficiently large reductions in cross-sectional area between sections, and accordingly necessitate a larger insert and/or inner nozzle. A preferred resonant insert may therefore include a maximum number of organ pipe sections producing effective resonance that are achievable with selected manufacturing methods and cavitation insert dimensions.

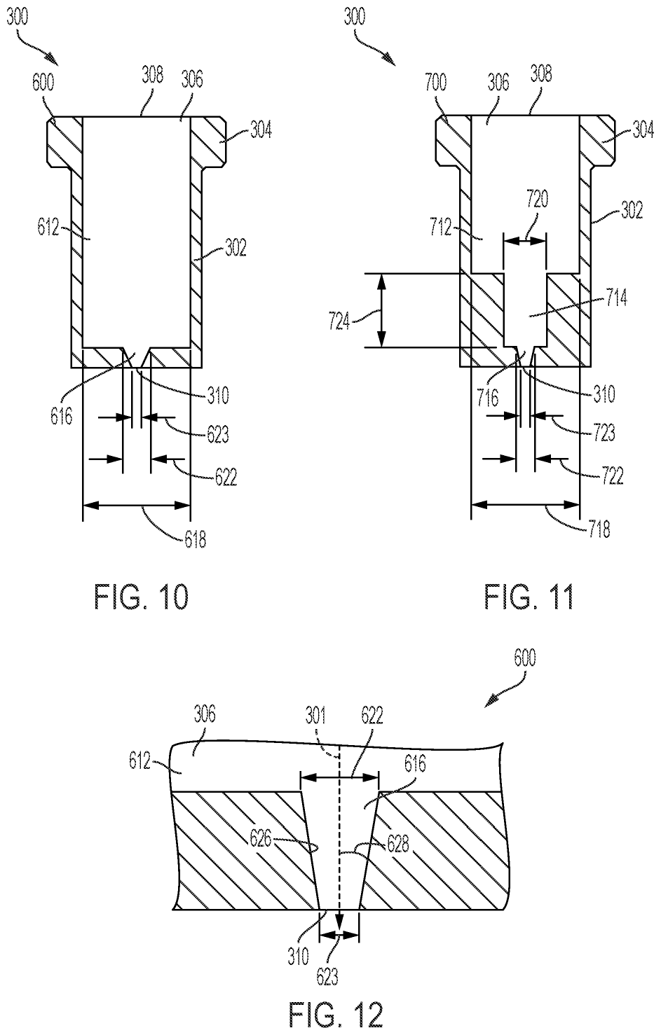

FIG. 10 depicts a third example of an enhanced intensity cavitation nozzle insert 300, a convergent insert 600 with a decreasing diameter outlet. Inner passage 306 of the convergent insert includes two sections: an inlet section 612 and an outlet section 616. The two sections are coaxial. Inlet section 612 is cylindrical with a constant diameter 618, while outlet section 616 converges from a first or entrance diameter 622 to a second or exit diameter 623. Exit diameter 623 is also the diameter of exit opening 310.

Convergent insert 600 may also be described as having two constrictions or reductions in cross-sectional area, where the change in diameter occurs from inlet section 612 to outlet section 616 and in outlet section 616 as the inner passage narrows from entrance diameter 622 to exit diameter 623.

The convergent geometry of outlet section 616 may increase velocity of the cavitating jet produced by convergent insert 600, thereby increasing a velocity difference between the inner and outer streams produced by the co-flow nozzle assembly. Such increased velocity difference may enhance cavitation action of the co-axial flows, and result in a higher occurrence of high intensity cavitation events.

Unlike the increased cavitation observed in divergent fuel injection nozzles, the geometry of convergent insert 600 may not be generated by pressure drops interior to the insert created by flow separation. Instead, increases in cavitation inception may occur at or outside exit opening 310 due to shearing action between flows. Such distribution may be advantageous for cavitation peening, avoiding damage to convergent insert 600 and improving cavitation effects at the work surface. Similar effects may be achieved with convergent outlet geometry in a submerged single-flow nozzle, by increasing shearing action between the produced cavitating jet and surrounding static liquid.

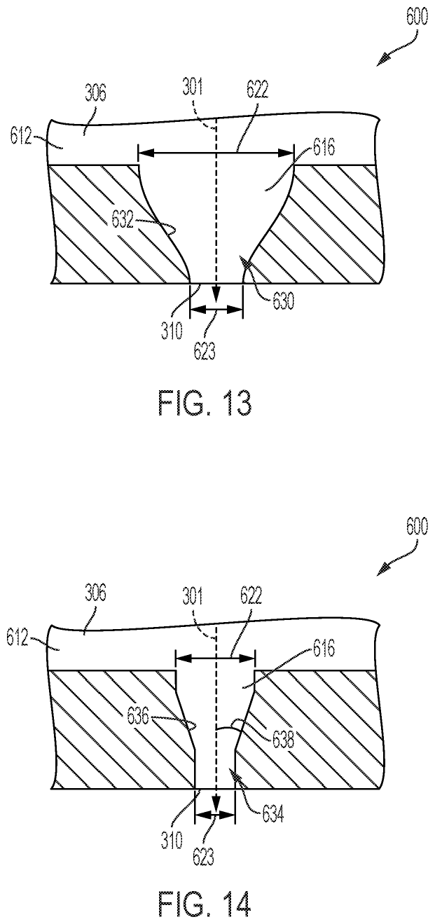

As depicted in FIG. 10, outlet section 616 of convergent insert 600 is conical in shape. The outlet section may also be described as frusticonical. Outlet section 616 is depicted in more detail in FIG. 12, and includes linearly sloped inner walls 626. The inner walls slope continuously from inlet section 612 to exit 310, forming an angle 628 with a central axis 301 of the insert. When convergent insert 600 is installed in nozzle assembly 200 as shown in FIG. 3, central axis 301 is coincident with central axis 202 of the nozzle assembly and inner walls 626 form angle 628 with central axis 202.

Referring again to FIG. 12, in the depicted example angle 628 is approximately 8 degrees. Entrance diameter 622 is approximately 910 micrometers (μm), and exit diameter 623 is approximately 845 μm. Outlet section 616 is circular in cross-section, perpendicular to central axis 301, along a full length of the section. The outlet decreases in cross-sectional area by approximately 15%. In general, a greater decrease in cross-sectional area may result in greater cavitation intensity, but may also increase energy loss. Therefore, a balance between increasing intensity and maintaining power may be desirable. Between approximately a 13 and 20% decrease in cross-sectional area may be preferable. In a frusticonical outlet such as outlet section 616, such reduction may be achieved by an angle 628 between approximately 1 and 15 degrees. Beyond 45 degrees, energy loss may outweigh any benefit to cavitation intensity.

In a comparative test between the zero conicity outlet design of unexcited cavitation insert 250 (FIGS. 3, 4) and a convergent insert with outlet 616 as depicted in FIG. 12, over multiple passes on an aluminum alloy strip at an optimum stand-off distance, the resonant insert demonstrated approximately a 20% increase in mass loss and a 65% increase in strip curvature. Approximately a 30% greater frequency of high intensity cavitation events was recorded.

Reduction in cross-sectional area of the outlet section of convergent insert 600 may also be achieved by other shapes. FIGS. 13 and 14 depict two examples of such shapes, each with an inner wall converging non-linearly. In the example depicted in FIG. 13, convergent insert 600 includes a curved outlet section 630. The curved outlet section includes approximately parabolic inner walls 632, similar to the shape of the convergent section of a de Laval nozzle or con-di nozzle. Curved outlet section 630 has a larger entrance diameter 622 and greater reduction in cross-sectional area, than conical outlet section 616 (FIG. 12). Such reduction in combination with the curvature may provide greater acceleration of the water flow, but may be more difficult and costly to manufacture at the micrometer scale needed for the present example of a hand-held co-flow nozzle assembly.

In the example depicted in FIG. 14, convergent nozzle 600 includes a stepped outlet section 634. The stepped outlet section includes three regions, a first cylindrical region, a second conical region, and a third cylindrical region. Inner walls 636 of the conical region form an angle 638 with central axis 301. Angle 638 is greater than angle 628 of conical outlet section 616 (FIG. 12), but stepped outlet 634 has the same entrance diameter 622 and reduction in cross-sectional area as the conical section. Stepped geometry such as that of outlet section 634 may be useful to achieve more subtle or complex alterations to water flow. Any effective combination of linear and/or curved regions may be used to achieve desired flow dynamics. Transitions between regions may be stepped, ramped or faired-in smoothly.

FIG. 11 depicts a fourth example of an enhanced intensity cavitation nozzle insert 300, a combination insert 700, with organ pipe geometry and a decreasing diameter outlet. Inner passage 306 of the combination insert includes three sections: an inlet section 712, an organ pipe section 714, and an outlet section 716. The inlet and organ pipe sections are each cylindrical, and all the sections are coaxial. Inlet section 712 has a diameter 718, organ pipe section 714 has a diameter 720, and outlet section 716 converges from an entrance diameter 722 to an exit diameter 723. Organ pipe section 714 also has a length 724, which may be selected according to a wavelength of a desired standing wave.

Diameter 718 is larger than diameter 720, which is larger than diameter 722, which is in turn larger than diameter 723. Combination insert 700 may also be described as having three constrictions or reductions in cross-sectional area, where the change in diameter occurs from inlet section 712 to organ pipe section 714, from the organ pipe section to outlet section 616, and in the outlet section as the inner passage narrows from entrance diameter 622 to exit diameter 623.

Combination insert 700 may produce the cavitation intensity enhancing effects on water flow of both resonant insert 400 (FIG. 8) and convergent insert 600 (FIG. 10). Pressure oscillations occurring at the nozzle exit may be intensified by reflections from the upstream contractions, and the convergent geometry of the outlet section may increase velocity of the produced cavitating jet. In some examples, combination insert 700 may include additional resonance chambers as depicted in FIG. 9 and/or non-linear outlet geometry such as depicted in FIGS. 13 and 14.

### B. Illustrative Method

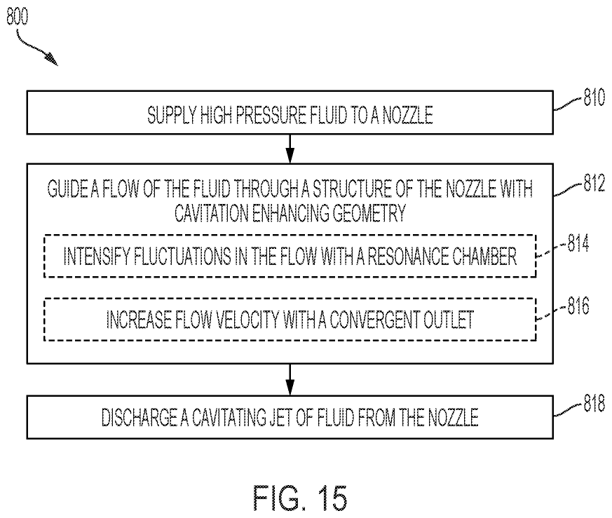

This section describes steps of an illustrative method 800 for cavitation peening; see FIG. 15. Aspects of cavitation nozzles described above may be utilized in the method steps described below. Where appropriate, reference may be made to components and systems that may be used in carrying out each step. These references are for illustration, and are not intended to limit the possible ways of carrying out any particular step of the method.

FIG. 15 is a flowchart illustrating steps performed in an illustrative method, and may not recite the complete process or all steps of the method. Although various steps of method 800 are described below and depicted in FIG. 15, the steps need not necessarily all be performed, and in some cases may be performed simultaneously or in a different order than the order shown.

At step 810, the method includes supplying high-pressure fluid to a nozzle. The nozzle may be a co-flow cavitation peening nozzle or a single flow cavitation peening nozzle submerged in a tank or other stationary column of fluid. High pressure fluid such as water may be supplied to the nozzle by a pump, at a selected pressure, flow rate, and/or temperature. The nozzle may be positioned at a selected standoff distance from a surface of a workpiece to be treated, by an automated system and/or by an operator. The workpiece may include any part, parts, and/or material requiring peening on one or more surfaces.

Step 812 of method 800 includes guiding a flow of the high-pressure fluid through a distal structure of the nozzle which has cavitation enhancing geometry. The nozzle may include an inner passage or bore, extending from a proximal or upstream end of the nozzle to a distal-most or downstream end of the nozzle. The inner passage may guide the supplied high-pressure fluid through the nozzle.

The distal structure of the nozzle may be disposed at the downstream end of the nozzle, and the cavitation enhancing geometry may include constrictions or reductions of cross-sectional area of the inner passage. The distal structure may comprise an integral portion of a unitary nozzle, may comprise a separate nozzle tip portion, and/or may comprise a modular interchangeable insert. The structure may be described as a cavitator, cavitation nozzle, and/or cavitation insert.

Optional sub-step 814 of step 812 includes intensifying fluctuations in the flow of high-pressure fluid with a resonance chamber. The resonance chamber may also be described as an organ pipe chamber and/or organ pipe geometry, and may be defined between two constrictions of the inner passage, in the distal structure of the nozzle. In other words, the distal structure may include two consecutive large reductions in cross-sectional area of the internal passage of the nozzle. Internal diameters of the structure may be selected to be sufficiently different as to generate an organ pipe effect. A length of the resonance chamber may be selected according to a desired resonance mode and/or other resonant properties. More specifically, the length may be selected according to a wavelength of a desired standing wave. Pressure oscillations occurring at an exit of the nozzle may be intensified by reflections from the upstream constrictions.

Optional sub-step 816 of step 812 includes increasing flow velocity with a convergent outlet. The convergent outlet may comprise a distal-most portion of the internal passage of the nozzle, defined in the distal structure. The convergent outlet may narrow from a first diameter at an upstream end of the outlet to a second diameter at a downstream end of the outlet. In some examples, the outlet may decrease linearly in diameter from the first diameter to the second diameter, for instance in a frusticonical shape. In some examples, the outlet may decrease monotonically but non-linearly from the first diameter to the second diameter, for instance in a parabolic shape. The convergent outlet may increase the velocity of fluid flow through the inner passage from the upstream end of the outlet to the downstream end of the outlet.

Step 818 includes discharging a cavitating jet of fluid from the nozzle. The cavitating jet may interact with a fluid environment such as a surrounding coaxial flow of low-pressure fluid or a static column of fluid to form a vortex cloud of cavitation bubbles. Collapse of the cavitation bubbles may peen the workpiece. Steps 810-818 of the method may be repeated throughout a peening treatment, as an automated system and/or operator scan the nozzle over a surface of the workpiece.

### Illustrative Combinations and Additional Examples

This section describes additional aspects and features of enhanced intensity cavitation nozzles and related systems and methods, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. An apparatus for cavitation peening, comprising:

a fluid source,

a conduit having a proximal end portion and a distal end portion, the proximal end portion being connected to the fluid source, and

a portable nozzle assembly connected to the distal end of the conduit, the nozzle assembling including:
an inner nozzle, including a cavitation insert and configured to channel a first stream of high-pressure fluid, and
an outer nozzle configured to channel a second stream of low-pressure fluid concentrically around the first stream,

wherein the cavitation insert has an inner passage with at least two reductions in cross-sectional area.

A1. The apparatus of A0, further including a plurality of interchangeable cavitation inserts, wherein the nozzle assembly is configured to allow replacement of the cavitation insert of the inner nozzle with another cavitation insert of the plurality of interchangeable cavitation inserts.

A2. The apparatus of A0 or A1, wherein the cavitation insert has organ pipe geometry.

A3. The apparatus of A2, wherein the inner passage of the cavitation insert is cylindrical and has a proximal section, a middle section, and a distal section, the proximal section having a first inner diameter, the middle section having a second inner diameter, and the distal section having a third inner diameter, the first inner diameter being larger than the second inner diameter, and the second inner diameter being larger than the third inner diameter.

A4. The apparatus of any of A0-A3, wherein the inner passage of the cavitation insert includes a proximal section and a distal section, the distal section converging from a first diameter to a second, smaller diameter.

A5. The apparatus of A4, wherein the distal section of the inner passage is defined by an inner wall forming an angle between approximately 1 and 15 degrees with a central axis of the nozzle assembly.

A6. The apparatus of any of A0-A5, wherein the portable nozzle assembly weighs less than 5 lbs.

A7. The apparatus of any of A0-A6, wherein the second stream is delivered from the outer nozzle through an aperture having a diameter of less than approximately 50 mm.

A8. The apparatus of any of A0-A7, wherein the second stream is delivered from a converging tip portion of the outer nozzle.

A9. The apparatus of A8, wherein the converging tip portion has an inner wall forming an angle between approximately 15 and 30 degrees with a central axis of the nozzle assembly.

A10. The apparatus of any of A0-A9, further comprising a feedback mechanism configured to indicate relative extent of surface modification at a work site being acted on by the nozzle assembly.

A11. The apparatus of any of A0-A10, wherein the nozzle assembly has an actuator configured for manual manipulation.

A12. The apparatus any of A0-A11, wherein the nozzle assembly includes a ring structure disposed in the outer nozzle, encircling the inner nozzle, and configured to maintain the inner nozzle in coaxial alignment with the outer nozzle while allowing fluid flow through the outer nozzle.

A13. The apparatus of any of A0-A12, wherein the nozzle assembly includes an annular plate having a plurality of circular holes, the annular plate being disposed in the outer nozzle, encircling the inner nozzle, and configured to homogenize fluid flow through the outer nozzle.

B0. A cavitation peening nozzle, comprising:

a cylindrical pipe, and

an organ pipe cavitator at a distal end of the cylindrical pipe, configured to deliver a cavitating jet of high-pressure fluid,

wherein an inner passage of the cavitator has a proximal section, a middle section, and a distal section, the proximal section having a first inner diameter, the middle section having a second inner diameter, and the distal section having a third inner diameter, the first inner diameter being larger than the second inner diameter, and the second inner diameter being larger than the third inner diameter.

B1. The nozzle of B0, wherein the first inner diameter is at least two times the size of the second inner diameter.

B2. The nozzle of B0 or B1, wherein the second inner diameter is at least four times the size of the third inner diameter.

B3. The nozzle of any of B0-B2, wherein the middle section has a length between 5-15 mm.

B4. The nozzle of any of B0-B3, wherein the middle section has a length between 5-10 mm.

B5. The nozzle of any of B0-B4, wherein the inner diameter of the third section is less than approximately 1 mm.

B6. The nozzle of any of B0-B5, wherein the organ pipe cavitator is configured to generate a cavitating jet having a Strouhal number of between 0.2 to 0.6.

B7. The nozzle of any of B0-B6, wherein the organ pipe cavitator is configured to generate a cavitating jet having a Strouhal number of approximately 0.28.

B8. The nozzle of any of B0-B7, further including a nozzle assembly configured to deliver a first stream of fluid through the cavitation peening nozzle, and a second stream of fluid concentrically around the first stream through an outer nozzle, the first stream being delivered at higher pressure than the second stream.

C0. A cavitation peening nozzle, comprising:

a cylindrical pipe, and

a converging cavitator at a distal end of the cylindrical pipe, configured to deliver

a cavitating jet of high-pressure fluid,

wherein an inner passage of the cavitator has an outlet section, the outlet section converging from a proximal opening to a smaller distal opening.

C1. The nozzle of C0, wherein a cross-sectional area of the distal opening is between approximately 10 and 30 percent less than a cross-sectional area of the proximal opening.

C2. The nozzle of C0 or C1, wherein the outlet section is defined by an inner wall of the converging cavitator, the inner wall forming an angle of at least approximately 8 degrees with a central axis of the nozzle assembly

C3. The nozzle of any of C0-C2, wherein the outlet section is frusticonical.

C4. The nozzle of any of C0-C3, wherein the outlet section is defined by an inner wall of the converging cavitator, the inner wall converging non-linearly from the proximal opening to the distal opening.

C5. The nozzle of any of C0-C4, further including a nozzle assembly configured to deliver a first stream of fluid through the cavitation peening nozzle, and a second stream of fluid concentrically around the first stream through an outer nozzle, the first stream being delivered at higher pressure than the second stream.

D0. An apparatus for cavitation peening, comprising:

a fluid source,

a conduit having a proximal end portion and a distal end portion, the proximal end portion being connected to the fluid source,

a portable nozzle assembly connected to the distal end of the conduit, wherein the nozzle assembly includes a cavitation nozzle having organ pipe geometry.

D1. The apparatus of D0, wherein the cavitation nozzle has an inner passage having a proximal section, a middle section, and a distal section, the proximal section having a first inner diameter, the middle section having a second inner diameter, and the distal section having a third inner diameter, the first inner diameter being larger than the second inner diameter, and the second inner diameter being larger than the third inner diameter.

D2. The apparatus of D0 or D1, wherein the nozzle assembly is configured to deliver a first stream of fluid through the cavitation nozzle, and a second stream of fluid concentrically around the first stream, the first stream being delivered at higher pressure than the second stream.

D3. The apparatus of D2, wherein the second stream is delivered from the nozzle assembly through an aperture having a diameter of at least approximately 20 mm.

D4. The apparatus of D2 or D3, wherein the second stream is delivered from the nozzle assembly through a funnel shaped tip portion of the nozzle assembly.

D5. The apparatus of D4, wherein the funnel shaped tip portion has an outer wall forming an angle of approximately 30 degrees with a central axis of the first fluid stream's flow direction.

E0. A cavitation peening nozzle assembly, comprising:

an outer pipe configured to channel a first fluid stream at a first fluid pressure,

an inner pipe concentric with the outer pipe and configured to channel a second fluid stream at a second fluid pressure, the second fluid pressure being higher than the first fluid pressure, and

an organ pipe nozzle at an outlet of the inner pipe,

wherein the first and second fluid streams combine to generate a cloud of cavitation bubbles.

F0. A cavitation peening co-flow nozzle assembly, comprising:

an outer pipe configured to channel a stream of low-pressure fluid, and

an inner pipe, including:

an inlet configured to receive a stream of high-pressure fluid,
a first constriction in a diameter of an internal passage of the inner pipe,
a second constriction in the diameter of the internal passage,
an outlet configured to deliver a cavitating jet of fluid,

wherein the first and second constrictions in diameter form a resonant chamber adjacent the outlet of the inner pipe.

G0. A portable cavitation peening system, comprising:

a high-pressure fluid source, and

a co-flow nozzle assembly having a resonance chamber configured to intensify fluctuations in a jet of the high-pressure fluid,

wherein the resonance chamber is defined between a first reduction in cross-sectional area of an inner pipe of the co-flow nozzle assembly, and a second reduction in cross-sectional area of the inner pipe.

H0. A method of cavitation peening, including:

discharging a cavitating jet of fluid concentric with and surrounded by a low-pressure jet of fluid, and

forming a cloud of cavitation bubbles at a work surface,

wherein discharging the cavitating jet of fluid includes directing a high-pressure stream of fluid through an organ pipe nozzle to intensify fluctuations in the stream of fluid.

### Advantages, Features, and Benefits

The different examples of the nozzle assembly described herein provide several advantages over known solutions for cavitation peening. For example, illustrative examples described herein exhibit improved cavitation intensity and higher frequency of strong cavitation events.

Additionally, and among other benefits, illustrative examples described herein require smaller pumps and less water flow.

Additionally, and among other benefits, illustrative examples described herein are smaller and lighter than existing co-flow nozzles.

Additionally, and among other benefits, illustrative examples described herein experience less wear and are longer lasting than un-excited nozzle geometries.

Additionally, and among other benefits, illustrative examples described herein are suitable for extended hand-held use.

Additionally, and among other benefits, illustrative examples described herein are modular to allow tailoring to specific peening applications.

No known system or device can perform these functions, particularly with high cavitation intensity from limited water flow. Thus, the illustrative examples described herein are particularly useful for portable cavitation peening systems. However, not all examples described herein provide the same advantages or the same degree of advantage.

### CONCLUSION

The disclosure set forth above may encompass multiple distinct examples with independent utility. Although each of these has been disclosed in its preferred form(s), the specific examples thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. An apparatus for cavitation peening, comprising:
a fluid source,
a conduit having a proximal end portion and a distal end portion, the proximal end portion being connected to the fluid source, and
a portable nozzle assembly connected to the distal end of the conduit, the nozzle assembling including:
an inner nozzle, including a cavitation insert and configured to channel a first stream of high-pressure fluid, and
an outer nozzle configured to channel a second stream of low-pressure fluid concentrically around the first stream,
wherein the cavitation insert has an inner passage with at least two reductions in cross-sectional area.

2. The apparatus of claim 1, further including a plurality of interchangeable cavitation inserts, wherein the nozzle assembly is configured to allow replacement of the cavitation insert of the inner nozzle with another cavitation insert of the plurality of interchangeable cavitation inserts.

3. The apparatus of claim 1, wherein the cavitation insert has organ pipe geometry.

4. The apparatus of claim 3, wherein the inner passage of the cavitation insert is cylindrical and has a proximal section, a middle section, and a distal section, the proximal section having a first inner diameter, the middle section having a second inner diameter, and the distal section having a third inner diameter, the first inner diameter being larger than the second inner diameter, and the second inner diameter being larger than the third inner diameter.

5. The apparatus of claim 1, wherein the inner passage of the cavitation insert includes a proximal section and a distal section, the distal section converging from a first diameter to a second, smaller diameter.

6. The apparatus of claim 5, wherein the distal section of the inner passage is defined by an inner wall forming an angle between approximately 1 and 15 degrees with a central axis of the nozzle assembly.

7. The apparatus of claim 1, wherein the portable nozzle assembly weighs less than 5 lbs.

8. The apparatus of claim 1, wherein the second stream is delivered from the outer nozzle through an aperture having a diameter of less than approximately 50 mm.

9. A cavitation peening nozzle, comprising:
a cylindrical pipe, and
an organ pipe cavitator at a distal end of the cylindrical pipe, configured to deliver a cavitating jet of high-pressure fluid,
wherein an inner passage of the cavitator has a proximal section, a middle section, and a distal section, the proximal section having a first inner diameter, the middle section having a second inner diameter, and the distal section having a third inner diameter, the first inner diameter being larger than the second inner diameter, and the second inner diameter being larger than the third inner diameter.

10. The nozzle of claim 9, wherein the first inner diameter is at least two times the size of the second inner diameter.

11. The nozzle of claim 9, wherein the second inner diameter is at least four times the size of the third inner diameter.

12. The nozzle of claim 9, wherein the middle section has a length between approximately 5 and 15 mm.

13. The nozzle of claim 9, wherein the organ pipe cavitator is configured to generate a cavitating jet having a Strouhal number between approximately 0.2 and 0.6.

14. The nozzle of claim 9, further including a nozzle assembly configured to deliver a first stream of fluid through the cavitation peening nozzle, and a second stream of fluid concentrically around the first stream through an outer nozzle, the first stream being delivered at higher pressure than the second stream.

15. A cavitation peening nozzle, comprising:
a cylindrical pipe, and
a converging cavitator at a distal end of the cylindrical pipe, configured to deliver a cavitating jet of high-pressure fluid,
wherein an inner passage of the cavitator has an outlet section, the outlet section converging from a proximal opening to a smaller distal opening.

16. The nozzle of claim 15, wherein a cross-sectional area of the distal opening is between approximately 10 and 30 percent less than a cross-sectional area of the proximal opening.

17. The nozzle of claim 15, wherein the outlet section is defined by an inner wall of the converging cavitator, the inner wall forming an angle of at least approximately 8 degrees with a central axis of the nozzle.

18. The nozzle of claim 15, wherein the outlet section is frusticonical.

19. The nozzle of claim 15, wherein the outlet section is defined by an inner wall of the converging cavitator, the inner wall converging non-linearly from the proximal opening to the distal opening.

20. The nozzle of claim 15, further including a nozzle assembly configured to deliver a first stream of fluid through the cavitation peening nozzle, and a second stream of fluid concentrically around the first stream through an outer nozzle, the first stream being delivered at higher pressure than the second stream.
